(19) United States
(12) Patent Application Publication
(10) Pub. No.: US 2010/0200263 A1
(43) Pub. Date: Aug. 12, 2010

(54) ELECTRICAL JUNCTION BOX FOR TOOL-LESS INSTALLATION OF POWER CABLES

(76) Inventor: ALEN TSENG, Taipei (TW)

Correspondence Address: John Alumit, 16830 Ventura Blvd. Suite 360, Encino, CA, 91436, US

(21) Appl. No.: 12/367,426

(22) Filed: Feb. 6, 2009

(51) Int. Cl. H01R 13/46

(52) U.S. Cl. 174/53

(57) ABSTRACT

An electrical junction box for tool-less installation of a plurality of power cables. The junction box comprises a rectangular shaped box, a pair of opposite end walls having an upper side and a lower side and a pair of opposite side walls, a plurality of notches in the upper side of the end wall, a plurality of holes in at least one side wall, a box cover having a distal end and a proximal end, a pair of hook members on the lower side of the end wall to hang the box cover from the rectangular shaped box in an open state, and a clamping member fixed across the upper side of the end wall to secure the box cover to the rectangular shaped box. The power cable is pushed to install in at least one notch having smooth edges which makes the power cable justly fit into the notch.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to electrical junction boxes having holes for inserting power cables, and more particularly to an electrical junction box featuring notches for tool-less installation of power cables.

Electrical junction boxes which are used to run multiple conductors in two or more directions to bring power to various electrical devices have been used for many years and are required by most. There are many designs for junction boxes ranging from the simple and small metal or plastic junction boxes used with conventional Romex wire for inside residential wiring to the large and complex junction boxes used in hazardous industrial environments.

Several junction boxes for quick and simple wiring have been developed in art. For example, U.S. Pat. No. 5,216,203 issued to Gower explains a junction box which is provided with a plurality of holes for the purpose of inserting insulated electrical wiring into the junction box. Hole cushions are fitted to the periphery of the holes to protect electrical wires entering the junction box from the bare edges which form the holes. Further, top and bottom insulated cushions protect the electrical wires from contacting interior sides of the top and floor of the junction box.

Likewise, U.S. Pat. No. 5,735,713 issued to Sugiura discloses an electrical junction box comprising a cover body having a plurality of cavities to engage with a plurality of electrical components, and separately provided rear covers for sub wire harnesses which are fixedly combined with the cover body. The connection of power lines is achieved with a general connector wherein the connector is connected to a housing provided on any one of the rear covers.

U.S. Pat. No. 5,902,960 issued to Smith teaches a cover for shielding the interior of an electrical wire junction box from foreign materials during wall construction. The cover has a frangible portion that can be bent back to create a slot for ease in removal of the cover from the junction box housing.

Electrical wiring in most of the above stated devices is time consuming and requires tools to install the electrical wires. In addition, in such devices hole cushions are fitted to the periphery of the holes to protect electrical wires from brushing and cutting which is complex to manufacture and therefore not economical. Moreover, a user can not easily use such devices for residential wiring as the electrical wire may not correctly fit into the holes provided on the junction box covers. If plastic junction box has to be used, it necessitates an additional wire to be run throughout the electrical system to act as a ground.

It is therefore, an object of the present invention to provide an electrical junction box for tool-less installation of power cables thereby saving time in installing the wires. Another object of the invention is to provide an electrical junction box having notches with smooth edges to protect electrical wires from brushing and cutting. A further object of the invention is to provide an electrical junction box which is simple to manufacture and economical. Other objects of the present invention will become better understood with reference to appended Summary, Description and Claims.

### SUMMARY

The present invention is an electrical junction box for tool-less installation of a plurality of electrical power cables. The electrical junction box comprises a rectangular shaped box having a rigid base, a pair of opposite end walls having an upper side and a lower side and a pair of opposite side walls, each wall projecting outwardly from the rigid base, a housing inside the rectangular shaped box, a plurality of notches in the upper side of the end wall, a plurality of holes in the at least one side wall, and a pair of hook members on the lower side of the end wall.

The electrical junction box further comprises a box cover having a distal end and a proximal end, a plurality of clips at a distal end of a box cover, and a clamping member fixed across the upper side of the end wall. The power cable is pushed to install the at least one notch which makes the power cable justly fit into the notches.

The housing is adapted to accommodate the plurality of electrical power cables. A user can insert the plurality of power cables in the junction box through at least one hole or notch as desired. The dimensions of the notches allow for a plurality of standard non-metallic sheathed cable types such as US #14/2, #14/3, #12/2, #12/3 and Canada #14/2, #14/3, #12/2 to justly fit through the notches. The notches are smooth on an edge to protect the power cables from brushing and cutting. The notches provided for the power cables are more convenient and economic than the holes-way for inserting the power cable. In the preferred embodiment, the notches are exactly three and the junction box is designed to support the pull of 20 pounds.

The hook members are utilized to hang the box cover from the rectangular shaped box to achieve an opened state of the electrical junction box. A pair of protrusion on the distal end of the box cover is oriented to stop the movement of the box cover when the junction box is in a closed state. The clamping member secures the box cover to the rectangular shaped box and a plurality of clips cut off when the power cable is fixed into the notch. Thus, the present invention enables a tool-less installation of the power cables and saves time.

### BRIEF DESCRIPTION OF THE FIGURES

FIG. 1 is a perspective view of the invention, illustrating an electrical junction box in a fully opened state.

FIG. 2 is a perspective view of the invention, illustrating an electrical junction box in a partially closed state.

FIG. 3 is a perspective view of the invention, illustrating an electrical junction box in a closed state.

FIG. 4 is a close perspective view of the invention, illustrating at least one notch that is smooth on an edge.

FIG. 5 is a perspective view of the invention, illustrating an electrical junction box in use.

FIG. 6 is an operational flow chart of the invention, illustrating a method for tool-less installation of a plurality of power cables in a junction box.

### REFERENCE NUMERALS

10 . . . An electrical junction box
12 . . . A plurality of electrical power cables
14 . . . A rectangular shaped box
16 . . . A rigid base
18 . . . A pair of opposite end walls
20 . . . An upper side of a pair of opposite end wall
22 . . . A lower side of a pair of opposite end wall
24 . . . A pair of opposite side wall
26 . . . A housing
28 . . . A plurality of notches
30 . . . A plurality of holes
32 . . . A pair of hook members
34 . . . An opened state of the electrical junction box
40 . . . A box cover
42 . . . A distal end of a box cover
44 . . . A proximal end of a box cover
46 . . . A plurality of clips
48 . . . A clamping member
52 . . . A pair of protrusion
54 . . . A closed state of the electrical junction box
62 . . . An edge of the at least one notch
72 . . . A power cable with metal tube around
80 . . . Operational flow chart illustrating a method for tool-less installation of power cables in a junction box
82 . . . Providing a rectangular shaped junction box
84 . . . Opening of box cover
86 . . . Pushing of power cables into notches
88 . . . Connecting power cables to relative power wires
90 . . . Closing of box cover

### DETAILED DESCRIPTION

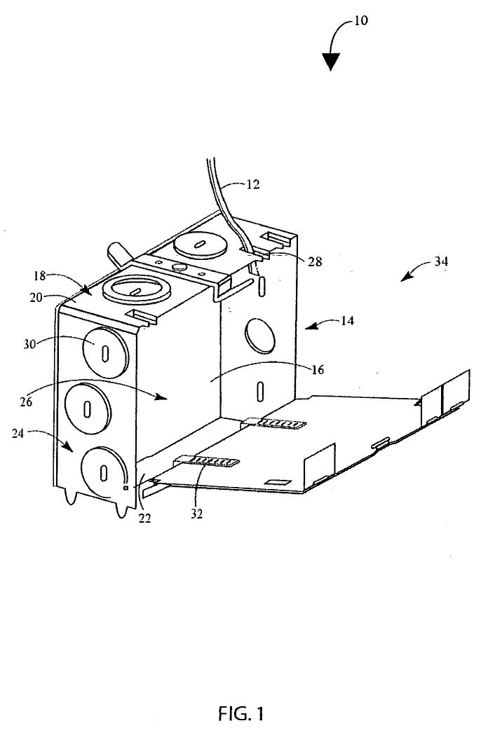

Referring to the drawings, a preferred embodiment of an electrical junction box 10 for tool-less installation of a plurality of electrical power cables 12 is illustrated from FIGS. 1 to 5. FIG. 1 shows the electrical junction box 10 in an opened state 34. The electrical junction box 10 comprises a rectangular shaped box 14 having a rigid base 16, a pair of opposite end walls 18 having an upper side 20 and a lower side 22 and a pair of opposite side walls 24 wherein each wall 18, 24 are projecting outwardly from the rigid base 16, and a housing 26 inside the rectangular shaped box 14, a plurality of notches 28 in the upper side of the end wall 20, a plurality of holes 30 in the at least one side wall 24, and a pair of hook members 32 on the lower side of the end wall 22.

The housing 26 is adapted to accommodate the plurality of electrical power cables 12. A user (not shown) can insert the plurality of power cables 12 into the junction box 10 through at least one hole 30 or notch 28 as desired. The dimensions of the notches 28 allow for a plurality of standard non-metallic sheathed cable types such as US #14/2, #14/3, #12/2, #12/3 and Canada #14/2, #14/3, #12/2 to justly fit through the notches 28. In the present invention there are exactly three notches 28. The holes 30 aggregate eight in which four of them can be used for the power cable 12 to come in and other four can be used for the power cable 12 to come out. The notches 28 provided for the power cable 12 are more convenient and economic than holes way for inserting the power cable 12 since the notches 28 enable tool-less installation of power cables 12 and save time.

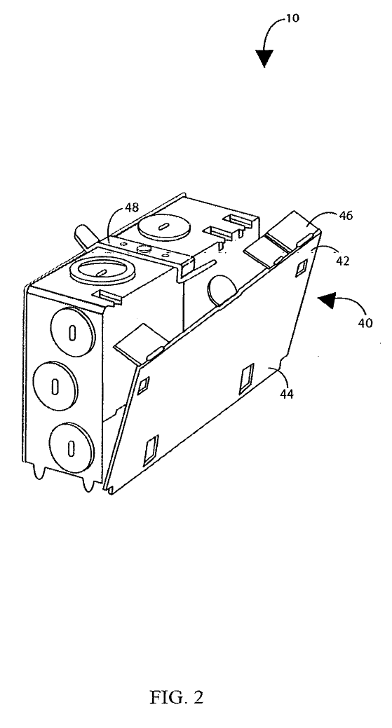

The hook members 32 are utilized to hang the box cover 40 from the rectangular shaped box 14 to achieve an opened state of the electrical junction box 34. As in FIG. 2, an electrical junction box 10 further comprises a box cover 40 having a distal end 42 and a proximal end 44, a plurality of clips 46 at a distal end of the box cover 42, and a clamping member 48 fixed across an upper side of an end wall 20. A power cable 12 is inserted to install in at least one notch 28 which makes the power cable 12 snugly fit into the notches 28.

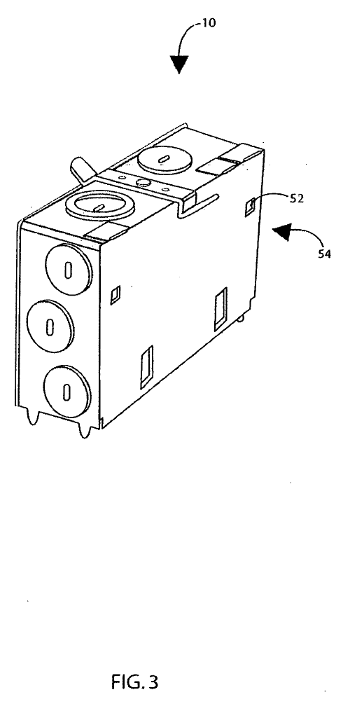

FIG. 3 illustrates a closed state of the electrical junction box 54. A pair of protrusion 52 on a distal end of a box cover 42 is oriented to stop the movement of the box cover 40. In the closed state 54, a clamping member 48 secures the box cover 40 to the rectangular shaped box 14 and a plurality of clips 46 cut off when a power cable 12 is fixed into a notch 28.

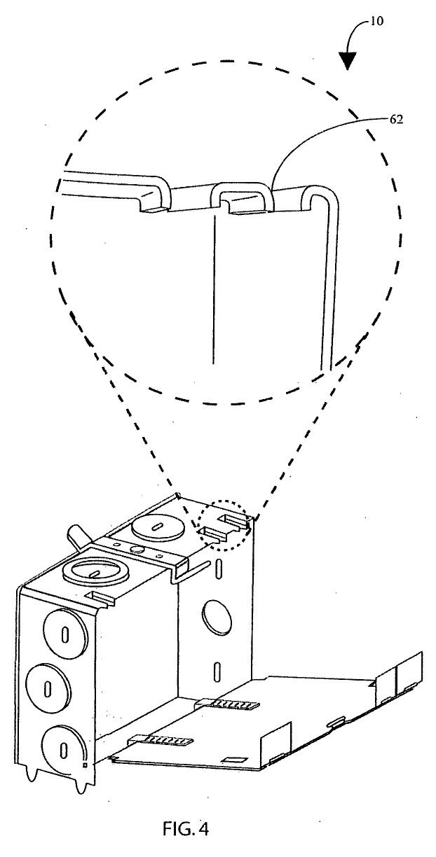

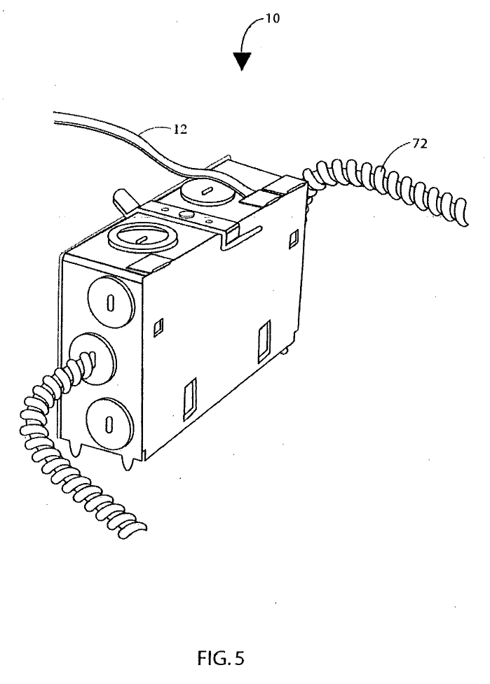

As in FIG. 4, a plurality of notches 28 is smooth on an edge 62 to protect a plurality of power cables 12 from brushing and cutting. FIG. 5 illustrates an electrical junction box 10 in which the power cable 12 is inserted through a notch 28 and a power cable with metal tube around 72 inserted through a hole 30. In the present invention, the junction box 10 is designed to support the pull of 20 pounds.

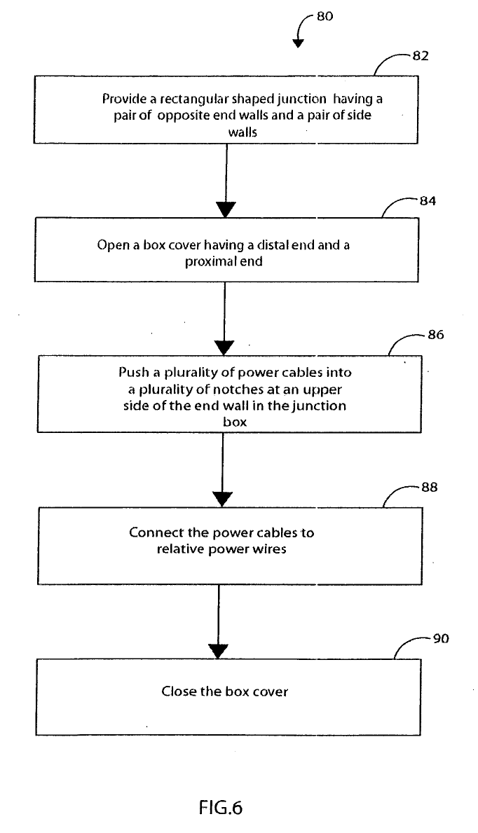

FIG. 6 is an operational flow chart 80 of a method for tool-less installation of a plurality of power cables in a rectangular shaped electrical junction box. The rectangular shaped junction box having a rigid base and a pair of opposite end and side walls is provided as indicated in block 82, and a box cover having a distal end and a proximal end is opened as indicated in block 84. Further, a plurality of power cables is inserted into a plurality of notches at an upper side of the end wall in the junction box as indicated in block 86, the power cables are connected to relative power wires as indicated in block 88, and the box cover is closed as indicated in block 90.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An electrical junction box for tool-less installation of a plurality of electrical power cables, comprising:
a generally rectangular shaped box having a rigid base;
a pair of opposite end walls having an upper side and a lower side and a pair of opposite side walls, each wall being projecting outwardly from the rigid base;
a housing inside the rectangular shaped box;
a plurality of notches in the upper side of the end wall;
a plurality of holes in at least one side wall;
a pair of hook members on the lower side of the end wall;
a box cover having a distal end and a proximal end;
a plurality of clips at the distal end of the box cover; and
a clamping member fixed across the upper side of the end wall;
whereby dimensions of the notches are designed to make the power cables justly fit into the notches.

2. The device of claim 1 wherein the housing is adapted to accommodate the plurality of electrical power cables.

3. The device of claim 1 wherein the plurality of power cables can be inserted into the electrical junction box through at least one hole or notch.

4. The device of claim 1 wherein the plurality of clips cut off when the plurality of power cable is fixed into the plurality of notches.

5. The device of claim 1 wherein the plurality of notches is smooth on an edge to protect the plurality of power cables from brushing and cutting.

6. The device of claim 1 wherein the pair of hook members are utilized to hang the box cover from the rectangular shaped box in an opened state of the electrical junction box.

7. The device of claim 1 wherein the clamping member secures the box cover to the rectangular shaped box in a closed state.

8. The device of claim 1 wherein a pair of protrusions on the distal end of the box cover is oriented to stop the movement of the box cover in the closed state.

9. The device of claim 1 wherein the plurality of notches are exactly three.

10. A method for tool-less installation of a plurality of electrical power cables in a junction box, the method comprising:
a) providing a rectangular shaped box having a pair of opposite end walls and a pair of side walls wherein the pair of end walls include an upper side and a lower side;
b) opening a box cover having a distal end and a proximal end, the box cover being attached with the rectangular shaped box with a pair of hook members at the lower side of the pair of opposite end walls;
c) pushing a plurality of power cables into a plurality of notches at the upper side of the end wall in the rectangular shaped box;
d) connecting the plurality of power cables to relative power wires; and
e) closing the box cover.

11. The method of claim 10 wherein the box cover includes a pair of protrusions at the distal end for orientation to stop the movement of the box cover.

12. The method of claim 10 wherein the pair of hook members on the lower side of the end wall is utilized to hang the box cover from the rectangular shaped box in an open state of the electrical junction box.

13. The method of claim 10 wherein a clamping member fixed across the upper side of the end wall secures the box cover to the rectangular shaped box.
